(19) United States
(12) Patent Application Publication
(10) Pub. No.: US 2020/0120102 A1
(43) Pub. Date: Apr. 16, 2020

(54) TECHNIQUES FOR PROTECTING AGAINST FLOW MANIPULATION OF SERVERLESS FUNCTIONS

(71) Applicant: Nuweba Labs Ltd., Tel Aviv-Jaffa (IL)

(72) Inventors: Yan CYBULSKI, Tel-Aviv (IL); Ori SARI, Tel-Aviv (IL)

(73) Assignee: Nuweba Labs Ltd., Tel Aviv-Jaffa (IL)

(21) Appl. No.: 16/598,349

(22) Filed: Oct. 10, 2019

Related U.S. Application Data
(60) Provisional application No. 62/744,099, filed on Oct. 10, 2018.

(51) Int. Cl. H04L 29/06; H04L 29/08; G06F 16/17

(52) U.S. Cl. CPC H04L 63/102; G06F 16/1734; H04L 67/30; H04L 63/20

(57) ABSTRACT

A system and method for protecting against flow manipulation of serverless functions. The method includes creating a profile for a serverless function, wherein the profile is created as an empty profile; generating a plurality of policies based on a plurality of log entries, wherein the plurality of policies defines allowable operations for the serverless function, wherein the plurality of log entries is recorded during monitoring of operation of the serverless function; updating the profile based on the plurality of policies to create a final profile, wherein the final profile includes at least one of the plurality of policies; monitoring operation of the serverless function to detect at least one violation of the profile, wherein the at least one violation includes a deviation from the allowable operations; and performing at least one mitigation action when the at least one violation of the profile is detected.

### CROSS-REFERENCE TO RELATED APPLICATIONS

This application claims the benefit of U.S. Provisional Application No. 62/744,099 filed on Oct. 10, 2018, the contents of which are hereby incorporated by reference.

### TECHNICAL FIELD

The present disclosure relates generally to serverless functions, and more specifically to protecting serverless functions against flow manipulation.

### BACKGROUND

Organizations have increasingly adapted their applications to be run from multiple cloud computing platforms. Some leading public cloud service providers include Amazon®, Microsoft®, Google®, and the like. Serverless computing platforms provide a cloud computing execution model in which the cloud provider dynamically manages the allocation of machine resources. Such platforms, also referred to as function as a service (FaaS) platforms, allow execution of application logic without requiring storing data on the client's servers. Commercially available platforms include AWS Lambda by Amazon®, Azure® Functions by Microsoft®, Google Cloud Functions Cloud Platform by Google®, OpenWhisk by IBM®, and the like.

“Serverless computing” is a misnomer, as servers are still employed. The name “serverless computing” is used to indicate that the server management and capacity planning decisions of serverless computing functions are not managed by the developer or operator. Serverless code can be used in conjunction with code deployed in traditional styles, such as microservices. Alternatively, applications can be written to be purely serverless and to use no provisioned services at all.

Further, FaaS platforms do not require coding to a specific framework or library. FaaS functions are regular functions with respect to programming language and environment. Typically, functions in FaaS platforms are triggered by event types defined by the cloud provider. Functions can also be triggered by manually configured events or when a function calls another function. For example, in Amazon® AWS®, such triggers include file (e.g., S3) updates, passage of time (e.g., scheduled tasks), and messages added to a message bus. A programmer of the function would typically have to provide parameters specific to the event source it is tied to.

A serverless function is typically programmed and deployed using command line interface (CLI) tools, an example of which is a serverless framework. In most cases, the deployment is automatic and the function's code is uploaded to the FaaS platform. A serverless function can be written in different programming languages, such as JavaScript®, Python®, Java®, and the like. A function typically includes a handler (e.g., handler.js) and third-party libraries accessed by the code of the function. A serverless function also requires a framework file as part of its configuration. Such a file (e.g., serverless.yml) defines at least one event that triggers the function and resources to be utilized, deployed or accessed by the function (e.g., database).

Some serverless platform developers have sought to take advantage of the benefits of software containers. For example, one of the main advantages of using software containers is the relatively fast load times as compared to virtual machines. However, while load times such as 100 ms may be fast as compared to VMs, such load times are still extremely slow for the demands of FaaS infrastructures.

FIG. 1 shows an example diagram 100 illustrating a FaaS platform 110 providing functions for various services 120-1 through 120-6 (hereinafter referred to as services 120 for simplicity). Each of the services 120 may utilize one or more of the functions provided by respective software containers 115-1 through 115-4 (hereinafter referred to as a software container 115 or software containers 115 for simplicity). Each software container 115 receives requests from the services 120 and provides functions in response. To this end, each software container 115 includes code of the respective function. When multiple requests for the same software container 115 are received around the same time, a performance bottleneck occurs.

One vulnerability in ephemeral execution environments is caused by the way in which functions are invoked. The ephemeral execution provides, on each execution, a clean environment without any changes that can occur after the code starts its execution without an unexpected bug or problem. However, this requires running servers for a prolonged time. Further, some FaaS providers offer environment reuse (container reuse) to compensate for high cold start time (or warm start). The ephemerality execution demonstrates a risk as the software container maintains persistency when an attacker successfully gains access to a function environment.

Another vulnerability can result from the manipulation of a serverless function's flow. Manipulating the flow can lead to malicious activity, such as remote code execution (RCE), data leaks, malware injection, and the like.

Another vulnerability in FaaS platforms results from an interface to a network (e.g., the Internet). Today, developers of serverless functions do not have fine-grained control over network traffic flowing in and out of a software container. For example, developers in an Amazon® cloud environment usually bind a Lambda serverless function to a virtual private cloud (VPC) of Amazon® to control the function's network traffic. The network traffic control is a suitable solution regarding price, performance (heavy performance degradation), and complexity of operation.

Another vulnerability in FaaS platforms is caused by use of credentials by functions to access external services. For example, one vulnerability may be caused by utilization of environment variables in order to simplify and abstract function configuration and the use of credentials such that accessing the credentials will also provide access to the credentials. The environment variables are provided through an API or user interface, and are utilized during invocation of a function. Sometimes the environment variables are stored in a secure way while on rest. Environment variables are also used to pass the function sensitive information, such as third-party credentials to be used inside the function in order to access APIs of third-party providers, such as Slack, GitHub, Twillo, and the like.

A provider of the FaaS platform can also inject into the environment the function credentials that grant access to other services inside the provider cloud (in AWS its IAM credentials). The credentials are injected using environment variables.

Some providers secure the credentials at rest or at runtime, or provide temporary credentials. For example, credentials may be retrieved at runtime and stored in memory. Although these techniques reduce the change of environment variable misuse, utilization of environment variables still poses security risks for the sensitive credentials that are visible inside the function environment. That is, an attacker who gains access to the function environment can leak the credentials and cause real damage to a company even if the credentials are valid for a short period of time (usually 1 hour).

Other vulnerabilities include misconfiguration of security settings (e.g., web application firewall) and logical vulnerabilities (due to incorrect coding). Such vulnerabilities are difficult to detect because they can appear as a regular traffic.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for protecting against flow manipulation of serverless functions. The method comprises: creating a profile for a serverless function, wherein the profile is created as an empty profile; generating a plurality of policies based on a plurality of log entries, wherein the plurality of policies defines allowable operations for the serverless function, wherein the plurality of log entries is recorded during monitoring of operation of the serverless function; updating the profile based on the plurality of policies to create a final profile, wherein the final profile includes at least one of the plurality of policies; monitoring operation of the serverless function to detect at least one violation of the profile, wherein the at least one violation includes a deviation from the allowable operations; and performing at least one mitigation action when the at least one violation of the profile is detected.

Certain embodiments disclosed herein also include a non-transitory computer readable medium having stored thereon causing a processing circuitry to execute a process, the process comprising: creating a profile for a serverless function, wherein the profile is created as an empty profile; generating a plurality of policies based on a plurality of log entries, wherein the plurality of policies defines allowable operations for the serverless function, wherein the plurality of log entries is recorded during monitoring of operation of the serverless function; updating the profile based on the plurality of policies to create a final profile, wherein the final profile includes at least one of the plurality of policies; monitoring operation of the serverless function to detect at least one violation of the profile, wherein the at least one violation includes a deviation from the allowable operations; and performing at least one mitigation action when the at least one violation of the profile is detected.

Certain embodiments disclosed herein also include a system for protecting against flow manipulation of serverless functions. The system comprises: a processing circuitry; and a memory, the memory containing instructions that, when executed by the processing circuitry, configure the system to: create a profile for a serverless function, wherein the profile is created as an empty profile; generate a plurality of policies based on a plurality of log entries, wherein the plurality of policies defines allowable operations for the serverless function, wherein the plurality of log entries is recorded during monitoring of operation of the serverless function; update the profile based on the plurality of policies to create a final profile, wherein the final profile includes at least one of the plurality of policies; monitor operation of the serverless function to detect at least one violation of the profile, wherein the at least one violation includes a deviation from the allowable operations; and perform at least one mitigation action when the at least one violation of the profile is detected.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram illustrating a function as a service (FaaS) platform providing functions for various services.

FIG. 2 is a diagram illustrating a FaaS platform utilized to describe various disclosed embodiments.

FIG. 3 is a flowchart illustrating the creation and implementation of a policy profile.

FIG. 4 is an example diagram illustrating the receipt and distribution of function operation logs and policy profiles over a network.

FIG. 5 is a schematic diagram of a hardware layer according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

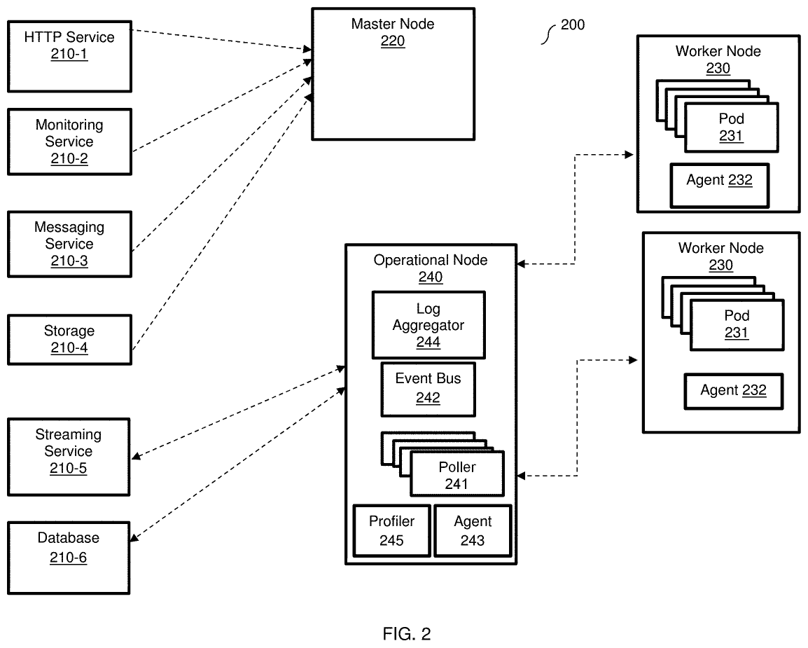

Some embodiments, disclosed herein, provide various security layers to detect and mitigate vulnerabilities in serverless functions. The serverless functions may be used, for example, in providing a function as a service (FaaS). The disclosed security layers are also operable in a commercially available FaaS platform supporting various types of functions, such as Amazon® Web Services (AWS) Lambda® functions, Azure® functions, and IBM® Cloud functions, and the like. In an embodiment, the security layers are operable in a secured scalable FaaS platform (hereinafter “the scalable FaaS platform”) designed according to some embodiments. An example scalable platform is provided below with reference to FIG. 2.

According to the disclosed embodiments, a security layer providing a process for creating policy profiles for the function operations of a client accessing a serverless function is provided. In this embodiment, the process is configured to log functions' operations and report the logs to the user in order to develop a policy profile. As a policy profile may include multiple policies for the various operations of a function, one policy profile may be applicable to govern the operations of one or more functions.

FIG. 2 is an example diagram of a scalable FaaS platform 200 designed according to an embodiment. The scalable FaaS platform 200 is configured to secure execution of serverless functions (hereinafter “functions” or a “function”), and in particular protecting against manipulation of the flow of serverless functions.

In the scalable FaaS platform 200, software container pods are utilized according to the disclosed embodiments. Each pod is a software container including code for a respective serverless function that acts as a template for each pod associated with that serverless function. When a function is called, it is checked if a pod containing code for the function is available. If no appropriate pod is available, a new instance of the pod is added to allow the shortest possible response time for providing the function. In some configurations, when an active function is migrated to a new FaaS platform, a number of initial pods are re-instantiated on the new platform.

In an embodiment, each request for a function passes to a dedicated pod for the associated function. In some embodiments, each pod only handles one request at a time such that the number of concurrent requests for a function that are being served are equal to the number of running pods. Instances of the same pod may share a common physical memory or a portion of memory, thereby reducing total memory usage.

The pods may be executed in different environments, thereby allowing different types of functions to be provided. For example, Amazon® Web Services (AWS) Lambda functions, Azure® functions, and IBM® Cloud functions may be provided using the pods deployed in a FaaS platform as described herein. The functions are services for one or more containerized application platform (e.g., Kubernetes®). A function may trigger other functions.

The disclosed scalable FaaS platform 200 further provides an ephemeral execution environment for each invocation of a serverless function. This ensures that each function's invocation is executed to a clean environment, i.e., without any changes that can occur after beginning execution of the code that can cause unexpected bugs or problems. Further, an ephemeral execution environment is secured to prevent persistency in case an attacker successfully gains access to a function environment.

To provide an ephemeral execution environment, the scalable FaaS platform 200 is configured to prevent any reuse of a container. To this end, the execution environment of a software container (within a pod) is completely destroyed at the end of the invocation and each new request is served by a new execution environment. This is enabled by keeping pods warm for a predefined period of time through which new requests are expected to be received.

In an embodiment, the scalable FaaS platform 200 is configured to handle three different types of events that trigger execution of serverless functions. Such types of events include synchronized events, asynchronized events, and polled events. The synchronized events are passed directly to a cloud service to invoke the function in order to minimize latency. The asynchronized events are first queued before invoking a function. The polled events cause an operational node (discussed below) to perform a time loop that will check against a cloud provider service, and if there are any changes in the cloud service, a function is invoked.

In the example embodiment illustrated in FIG. 2, the scalable FaaS platform 200 provides serverless functions to services 210-1 through 210-6 (hereinafter referred to individually as a service 210 or collectively as services 210 for simplicity) through the various nodes. In an embodiment, there are three different types of nodes: a master node 220, a worker node 230, and an operational node 240. In an embodiment, the scalable FaaS platform 200 includes a master node 220, one or more worker nodes 230, and one or more operational nodes 240.

The master node 220 is configured to orchestrate the operation of the worker nodes 230 and an operational node 240. A worker node 230 includes pods 231 configured to execute serverless functions. Each such pod 231 is a software container configured to perform a respective function such that, for example, any instance of the pod 231 contains code for the same function. The operational nodes 240 are utilized to run functions for the streaming and database services 210-5 and 210-6. The operational nodes 240 are further configured to collect logs and data from worker nodes 230.

In an embodiment, each operational node 240 includes one or more pollers 241, an event bus 242, and a log aggregator 244. A poller 241 is configured to delay provisioning of polled events indicating requests for functions. To this end, a poller 241 is configured to perform a time loop and to periodically check an external system (e.g., a system hosting one or more of the services 210) for changes in the state of a resource, e.g., a change in a database entry. When a change in state has occurred, the poller 241 is configured to invoke the function of the respective pod 231.

The event bus 242 is configured to allow communication between the other nodes and the other elements (e.g., the poller 241, log aggregator 244, or both) of the operational node 240. The log aggregator 244 is configured to collect logs and other reports from the worker nodes 230.

In an example implementation, the poller 241 may check the streaming service 210-5 and the database 210-6 for changes in state and, when a change in the state of one of the services 210-5 or 210-6 has occurred, invoke the function requested by the respective service 210-5 or 210-6.

In an embodiment, the operational node 240 additionally includes a profiler 245, which operates to receive function operation logs and generate policy profiles based on user input, AI input, or a combination of the two. It should be noted that, while the profiler 245 is included in the operational node 240 for purposes of illustration, the profile may alternatively be included in any node, including worker nodes 230 or the master node 220, without departing from the scope of the described embodiment.

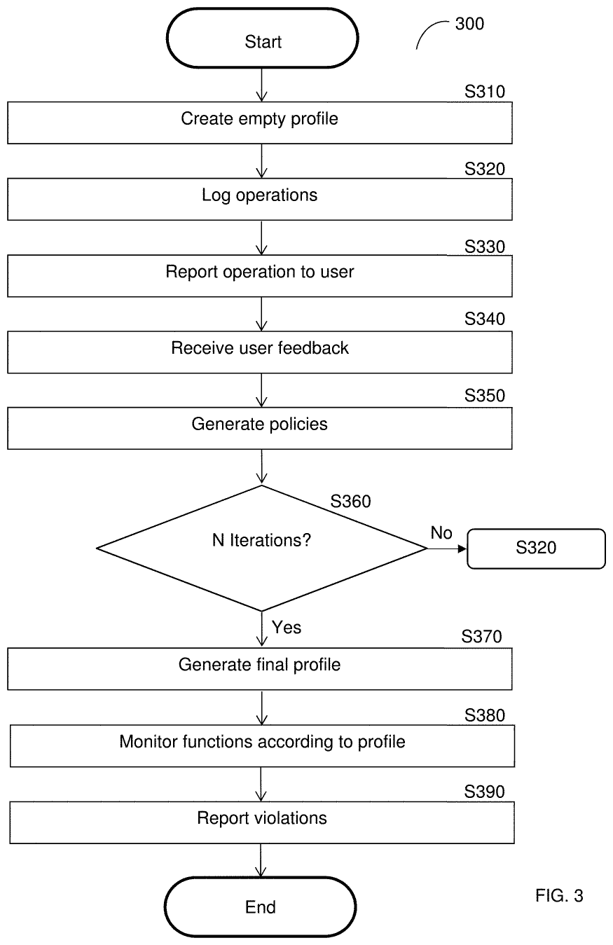

In an embodiment, the profiler 245 is configured to perform the various embodiments disclosed herein and, in particular, the embodiments described further below with respect to FIG. 3. To this end, the profiler 245 is configured to participate in a learning period during which normal operations of the functions of the pods 231 are learned. Data collected during the learning period is used to create a profile for each function. Once the learning period is completed, the profile may be used to detect violations based on subsequent traffic. The profiler 245 may further be configured to perform mitigation actions when violations are detected.

In an embodiment, the operational node 240 and the worker nodes 230 each include an agent 243,232, which may be configured to log function operation information, maintain the logged information in a format accepted by the profiler 245, and pass the logged information to the profiler 245 for the generation of function operation policy profiles.

The master node 220 further includes a queue, a scheduler, a load balancer, and an auto-scaler (not shown in FIG. 2A), utilized during the scheduling of functions. The autoscaler is configured to scale the pod services according to demand based on events representing requests (e.g., from a kernel, for example a Linux kernel, of an operating system). To this end, the autoscaler is configured to increase the number of pods as needed and that are available on-demand, while ensuring low latency. For example, when a request for a function that does not have an available pod is received, the autoscaler increases the number of pods. Thus, the autoscaler allows for scaling the platform per request.

The events may include, but are not limited to, synchronized events, asynchronized events, and polled events. The synchronized events may be passed directly to the pods to invoke their respective functions. The asynchronized events may be queued before invoking the respective functions.

It should be noted that, in a typical configuration, there is a small number of master nodes 220 (e.g., 1, 3, or 5 master nodes), and a larger number of worker nodes 230 and operational nodes 240 (e.g., millions). The worker nodes 230 and operational nodes 240 are scaled on demand.

The nodes 220, 230, and 240 may provide a different FaaS environment, thereby allowing for FaaS functions, for example, of different types and formats (e.g., AWS® Lambda, Azure®, and IBM® functions). The communication among the nodes 220 through 240 and the services 210 may be performed over a network, e.g., the internet (not shown).

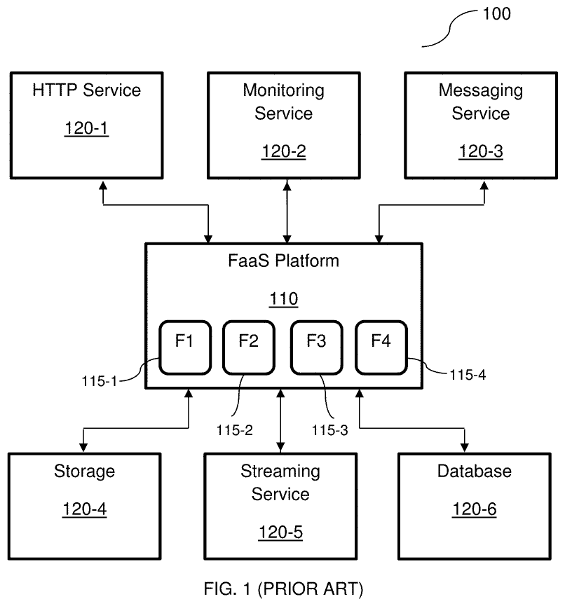

In some implementations, the FaaS platform 200 may allow for seamless migration of functions used by existing customer platforms (e.g., the FaaS platform 110, FIG. 1). The seamless migration may include moving code and configurations to the FaaS platform 200.

It should be further noted that each of the nodes shown in FIG. 2 requires an underlying hardware layer (not shown in FIG. 2) to execute the operating system, the pods, load balancers, and other functions of the master node.

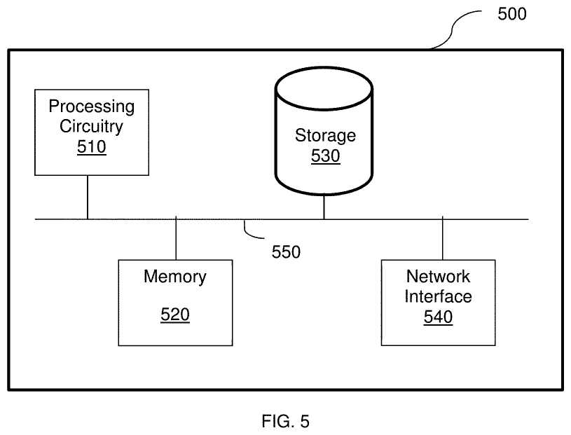

An example block diagram of a hardware layer is provided in FIG. 5. Furthermore, the various elements of the nodes 220 and 240 (e.g., the scheduler, autoscaler, pollers, event bus, log aggregator, etc.), the agents, and profiler 245 can be realized as pods. As noted above, a pod is a software container. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). Such Instructions are executed by the hardware layer.

It should be noted that the services 210 are merely examples, and that more, fewer, or other services may be provided functions by the FaaS platform 210 according to the disclosed embodiments. The services 210 may be hosted in an external platform (e.g., a platform of a cloud service provider utilizing the provided functions in its services). Requests from the services 210 may be delivered via one or more networks (not shown). It should also be noted that the numbers and arrangements of the nodes 211 and the pods 216 are merely illustrative, and that other numbers and arrangements may be equally utilized. In particular, the number of pods 216 may be dynamically changed as discussed herein to allow for scalable provisions of functions.

It should also be noted that the flows of requests shown in FIG. 2 (as indicated by dashed lines with arrows in FIG. 2) are merely examples used to demonstrate various disclosed embodiments and that such flows do not limit the disclosed embodiments.

In an embodiment, to ensure that every operating worker node 230 within a given cluster will be up-to-date on the appropriate function profiles, a master distribution server may be employed. By using a master distribution server, in combination with distribution clients on the individual nodes, system administrators may ensure that every worker node on the cluster has all the relevant functions' profiles loaded to their respective kernels.

According to the disclosed embodiments, the FaaS platform 200 is configured to implement a number of security layers to secure the platform 200, executed pods, and functions. The security layers are designed to defend against variabilities, such as the variabilities discussed above.

FIG. 3 depicts an example flowchart 300 illustrating protecting serverless functions from flow manipulation according to an embodiment. In an example implementation, the method of FIG. 3 may be applied to protect a serverless function from flow manipulation.

At S310, an empty profile is generated when a new function is created.

When the empty profile has been created, the process proceeds to a learning period during which normal operations of the function are learned. In the example implementation shown in FIG. 3, the learning period includes steps S320 through S370.

At S320, function operation logs are received. The function operation logs include log entries representing and including information related to activities performed by the serverless function.

At S330, a set of function operations is generated and sent to a user. In an embodiment, S330 includes abstracting the log entries in order to separate the operations from the raw data contained in the log. The set of function operations may be sent to a user device of the user, thereby allowing the user to mark each operation as allowed, denied, or flagged for audit.

At S340, the markings by the user may be received as user feedback.

At S350, a set of policies is created or updated and added to the profile. The set of policies is created based at least on the log entries, and may be further based on the user feedback. The set of policies includes rules defining allowable or otherwise normal activity for the serverless function.

In an embodiment, the log entries are received and utilized to created or updated iteratively. As the process repeats, the policies can become more general. For example, the policy based on the first set of prompts may allow the function access to resources in subdirectory B of directory A, where a more developed policy, based on a larger number of iterations, may allow the function access to all of directory A. As a non-limiting example, when a first iteration only involved accessing subdirectory B but subsequent iterations involved accessing other portions of directory A, this more general policy may be created.

At S360, it is checked if the operation log count has reached a threshold number of iterations “n” and, if so, execution continues with S370; otherwise, execution continues with S320. The number of iterations “n” used to limit the training of the profile during the learning period may be a predetermined number (e.g. 40 iterations).

At S370, when the threshold number of iterations has occurred, a final profile is generated.

At optional S380, operation of the serverless function is monitored for violations based on the final profile.

At optional S390 any detected violations are reported. In some implementations, function execution may proceed normally while violations are detected and reported.

It should be noted that, after the learning period is completed, the user may decide whether to enforce the profile, to selectively enforce certain policies, to restrict certain function operations, or a combination thereof. To this end, the user may determine whether certain operations specified in the various policies are legitimate, and may add the legitimacy policy to the profile, either by adding a new policy or by making an existing policy generic enough to include the given case.

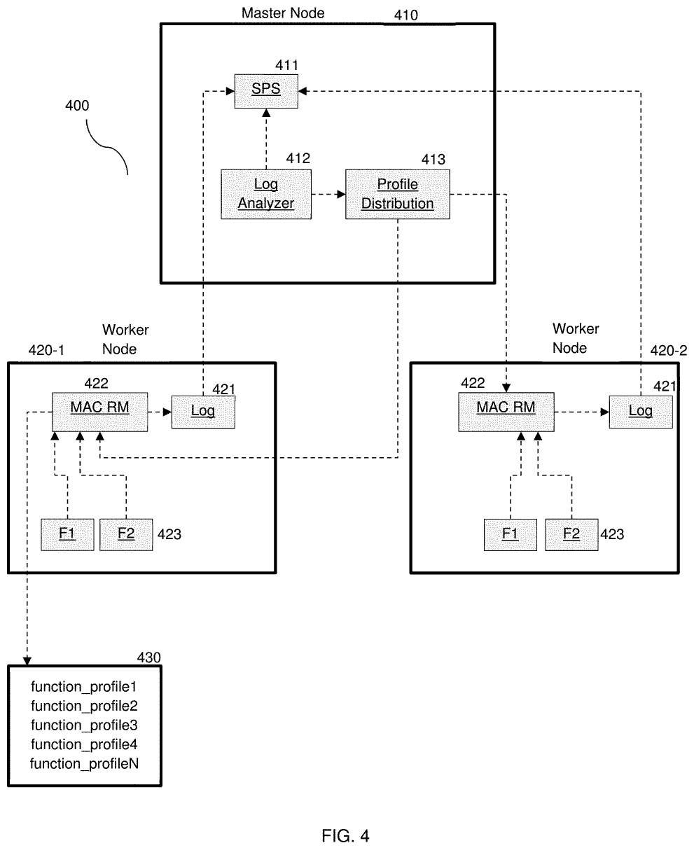

FIG. 4 depicts an example configuration of master/worker node architecture 400 incorporating a streaming platform (e.g., Apache Kafka®) server and log analysis. FIG. 4 illustrates distribution of profiles. In order to ensure that profile violation/operation logs 421 are properly collected, archived, and analyzed, a system administrator may configure a streaming platform server (SPS) 411 to receive collected logs after the end of a function's 423 log and to analyze the log files through a log analyzer 412. The streaming platform server 411 may be configured to analyze the collected logs according to the users' inputs and to generate function profiles, distributing the profiles to the worker nodes 420 through the profile distributor 413. The worker nodes 420 may be, for example, the worker nodes 230 described with respect to FIG. 2. The master node 410 may be, for example, the master node 220 described with respect to FIG. 2.

The application of profile-violation analysis may include runtime aware security. For a function (e.g., the function F1 or F2) 423 with a defined profile, a violation of that profile's policies may occur during the run of the function 423. In such a case, the system may be configured to assess the location of the violation within the code (e.g. the specific library) and display a traceback for user analysis.

The profiling layer is designed to prevent manipulation of the function's 423 flow. In an embodiment, a profile is generated to describe legitimate operations of a function 423 including operations that a sub-process of the function 423 can run. For example, this security layer can give the user abstractions for choosing a set of allowed operations, denied operations, and operations flagged for audit. In an embodiment, the profile is created, during a learning period, using one or more machine learning techniques. Further, the generated profiles can be modified to be generic enough to allow a function 423 to run normally during execution, while preventing flow intervention by malicious functions. The modification can be performed using machine learning techniques.

In an embodiment, the layer is based on a Mandatory Access Control (MAC) restriction mechanism (MAC RM) 422. The MAC restriction mechanism 422 may be an application cyber-security module (e.g., AppArmor) configured with executed processes arguments, detection and prevention modes per policy rather than per profile, and a logging mechanism. The safety mechanism may restrict programs to a limited set of resources as defined by a profile. Each profile includes a set of rules, also known as policies. All resources that are not allowed in the profile are denied. In an example implementation, each profile has two modes: Detect and Prevent. In Detect mode, log records are written for any violation of the profile; in Prevent mode, violated system calls are blocked (e.g., by failing the system call or terminating the process).

Typically, most of the rules in the profile are based on file rules. In an embodiment, the file rules define a path to one or more files and means by which each program can access the file (read, write, mapping, executing). In case of execution, the profile can further define sub-profiles which can be applied to the executed program.

According to the disclosed embodiments, when a user creates a new function, an empty profile is created. Log entries for the newly created function are monitored and recorded during a learning period. The log entries recorded during the learning period are converted into policies (e.g., safety mechanism rules) to create a basic profile for the function. Once the basic profile is created, the function includes a profile-building characteristic for a predefined time period. In addition, rules can become more generic.

As a non-limiting example, a first function's profile contains a write access for the path: /tmp/tmp-1234. During profile-building, the following write requests are detected: /tmp/tmp-4317, /tmp/tmp-4910, etc. The rule will become: /tmp/tmp-[0-9][0-9][0-9][0-9].

At the end of the profile-building period (e.g., when a threshold number of iterations has occurred), the profile is finalized, new function operations are not automatically added to the profile, and any violation of the profile is reported. Since the profile is still in a learning period, the function's execution is not interrupted. The reporting of violations allows the user to decide whether to add the detected violation to the profile as a legitimate operation. The user can also decide if the profile or a specific rule will be in enforce mode. If the user decides that the violating operation should be considered as a legitimate operation, this operation will be added to the profile (either by just adding it as a rule or by making another rule more generic so it will cover this operation).

In an embodiment, the duration of the learning period may be set to a predetermined number of runs of the function or a predefined time period. It should be noted that, at any moment, every worker node on the cluster should have all the functions' profiles loaded to its kernel. Any new profile (modified or new) is distributed and loaded to the nodes using a distribution server on the master node and distribution clients on the nodes.

In an embodiment, the collection of logs includes receiving information about profile violation to be collected and analyzed the logs. The collected logs are sent to a server within the master node. As noted above, the collected logs are analyzed for notification\modification\creation of profiles. The profile distribution is further illustrated in FIG. 3.

It should be appreciated that embodiments disclosed herein can be utilized to defend against malicious activity such as RCE, data leaks, malware injection, and the like.

FIG. 5 is an example block diagram of a hardware layer 500 included in each node according to an embodiment. That is, each of the master node, operational node, and worker node is independently executed over a hardware layer, such as the layer shown in FIG. 5.

The hardware layer 500 includes a processing circuitry 510 coupled to a memory 520, a storage 530, and a network interface 540. In another embodiment, the components of the hardware layer 500 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 520 may be volatile (e.g., RAM, etc.), non-volatile (e.g., ROM, flash memory, etc.), or a combination thereof. In one configuration, computer readable instructions to implement one or more embodiments disclosed herein may be stored in the storage 530.

In another embodiment, the memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, configure the processing circuitry 510 to perform the various processes described herein.

The storage 530 may be magnetic storage, optical storage, and the like, and may be realized, for example, as flash memory or other memory technology, CD-ROM, Digital Versatile Disks (DVDs), or any other medium which can be used to store the desired information.

The network interface 540 allows the hardware layer 500 to communicate over one or more networks, for example, to receive requests for functions from user devices (not shown) for distribution to software containers (e.g., the pods 231, FIG. 2).

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for protecting against flow manipulation of serverless functions, comprising:
creating a profile for a serverless function, wherein the profile is created as an empty profile;
generating a plurality of policies based on a plurality of log entries, wherein the plurality of policies defines allowable operations for the serverless function, wherein the plurality of log entries is recorded during monitoring of operation of the serverless function;
updating the profile based on the plurality of policies to create a final profile, wherein the final profile includes at least one of the plurality of policies;
monitoring operation of the serverless function to detect at least one violation of the profile, wherein the at least one violation includes a deviation from the allowable operations; and
performing at least one mitigation action when the at least one violation of the profile is detected.

2. The method of claim 1, wherein generating the plurality of policies further comprises:
iteratively generating a plurality of sets of policies, wherein the final profile is created when a threshold number of iterations of sets of policies have been generated, wherein the final profile is created based on the last generated set of policies.

3. The method of claim 2, wherein iteratively generating the plurality of sets of policies includes generalizing at least one of the policies of the plurality of sets of policies.

4. The method of claim 1, wherein the serverless function is configured to execute at least one sub-process, wherein the final profile defines at least one allowable operation of the at least one sub-process.

5. The method of claim 1, wherein the final profile is created based further on at least one user input with respect to the plurality of log entries.

6. The method of claim 5, wherein the at least one user input indicates at least one of: that at least one log entry represents an allowed operation, that at least one log entry represents a denied operation, and that at least one log entry requires auditing.

7. The method of claim 5, further comprising:
abstracting the plurality of log entries, wherein the abstracted plurality of log entries is sent to a user device, wherein the at least one user input is received from the user device.

8. A non-transitory computer readable medium having stored thereon instructions for causing a processing circuitry to execute a process, the process comprising:
creating a profile for a serverless function, wherein the profile is created as an empty profile;
generating a plurality of policies based on a plurality of log entries, wherein the plurality of policies defines allowable operations for the serverless function, wherein the plurality of log entries is recorded during monitoring of operation of the serverless function;
updating the profile based on the plurality of policies to create a final profile, wherein the final profile includes at least one of the plurality of policies;
monitoring operation of the serverless function to detect at least one violation of the profile, wherein the at least one violation includes a deviation from the allowable operations; and
performing at least one mitigation action when the at least one violation of the profile is detected.

9. A system for protecting against flow manipulation of serverless functions, comprising:
a processing circuitry; and
a memory, the memory containing instructions that, when executed by the processing circuitry, configure the system to:
create a profile for a serverless function, wherein the profile is created as an empty profile;
generate a plurality of policies based on a plurality of log entries, wherein the plurality of policies defines allowable operations for the serverless function, wherein the plurality of log entries is recorded during monitoring of operation of the serverless function;
update the profile based on the plurality of policies to create a final profile, wherein the final profile includes at least one of the plurality of policies;
monitor operation of the serverless function to detect at least one violation of the profile, wherein the at least one violation includes a deviation from the allowable operations; and
perform at least one mitigation action when the at least one violation of the profile is detected.

10. The system of claim 9, wherein the system is further configured to:
iteratively generate a plurality of sets of policies, wherein the final profile is created when a threshold number of iterations of sets of policies have been generated, wherein the final profile is created based on the last generated set of policies.

11. The system of claim 10, wherein iteratively generating the plurality of sets of policies includes generalizing at least one of the policies of the plurality of sets of policies.

12. The system of claim 9, wherein the serverless function is configured to execute at least one sub-process, wherein the final profile defines at least one allowable operation of the at least one sub-process.

13. The system of claim 9, wherein the final profile is created based further on at least one user input with respect to the plurality of log entries.

14. The system of claim 13, wherein the at least one user input indicates at least one of: that at least one log entry represents an allowed operation, that at least one log entry represents a denied operation, and that at least one log entry requires auditing.

15. The system of claim 13, wherein the system is further configured to:
abstract the plurality of log entries, wherein the abstracted plurality of log entries is sent to a user device, wherein the at least one user input is received from the user device.
